(19) United States
(12) Patent Application Publication
(10) Pub. No.: US 2016/0016476 A1
(43) Pub. Date: Jan. 21, 2016

(54) SYSTEMS AND METHODS FOR COLLECTING, STORING AND USING ELECTRICAL ENERGY FROM THE EARTH MAGNETIC FIELD

(71) Applicant: Albert James Lovshin, Butte, MT (US)

(72) Inventor: Albert James Lovshin, Butte, MT (US)

(21) Appl. No.: 14/802,987

(22) Filed: Jul. 17, 2015

Related U.S. Application Data
(60) Provisional application No. 61/999,191, filed on Jul. 17, 2014.
(60) Provisional application No. 62/070,211, filed on Aug. 19, 2014.

(51) Int. Cl. B60L 11/04; H02K 47/14

(52) U.S. Cl. CPC B60L 11/04; H02K 47/14; Y10S 74/09; H02K 53/00

(57) ABSTRACT

Methods and systems for using the Earth's magnetic field to power a machine having a motor, the system including a computer, a plurality of wires, a plurality of energy storing devices, all in controlled electrical communication with each other, wherein the plurality of wires can collect electrical energy from the Earth's magnetic field while the machine is put in motion by a power source powering the motor, wherein the collected electrical energy is stored in the plurality of energy storing devices or used to power the motor.

### CROSS-REFERENCE TO RELATED APPLICATIONS

This application claims the benefit of U.S. Provisional Application No. 61/999,191, filed Jul. 17, 2014, and U.S. Provisional Application No. 62/070,211, filed Aug. 19, 2014, which are hereby incorporated by reference, to the extent that they are not conflicting with the present application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates generally to technologies based on the Earth magnetic field and more particularly to methods and systems for using the Earth's magnetic field as a source of energy for powering electric vehicles or other devices.

2. Description of the Related Art

With growing demand for renewable energy, many consumers are choosing hybrid or electric vehicles. However, there are many obstacles to overcome for electric cars to become practical for widespread use. Many consumers are concerned with the range they are able to drive before requiring time-consuming charging, and much of today's infrastructure would have to be changed to alleviate this problem. Also, since the electricity is often generated initially through fossil fuels, electric vehicles are not using a truly renewable resource for power. There is still a need for a renewable resource to power vehicles without frequent and time-consuming charging.

It is known in the prior art that moving a conductive coil of wire through a magnetic field can produce an electrical current in the wire. The direction of the current through the wire is dependent on the relative direction of motion between the coil of wire and the magnetic field, and the voltage V generated by a wire of length l moving through a magnetic field B at velocity v is given by the equation:

V=B×l×v

This concept may be used in the generation of an electrical current for, for example, a vehicle, to address the need for a renewable resource to power vehicles and for avoiding frequent and time-consuming charging.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one aspect, this invention may have as its objective the ability to generate electricity from the Earth's magnetic field while in motion to supply power to energy storing devices, such as supercapacitors, for example, as means for powering a vehicle.

Using the principle described by the equation above, the voltage from the wire may be supplied into a plurality of energy storing devices, such as supercapacitors. As the vehicle travels, the wires may be moved through the Earth's magnetic field, and may charge the supercapacitors, which may discharge to the motor. The wire may be copper or any other conductive material.

In one exemplary embodiment, a system of wires arranged in any configuration deemed suitable supplying power to supercapacitors discharging to a motor in a vehicle is provided. The supercapacitors may be connected to both the wires which supply the electrical current generated by the Earth's magnetic field, and to the vehicle's motor through a computer interface bus. Thus, an advantage is that the system eliminates the need for the vehicle to be recharged or for the purchase of gasoline or electricity by the user. Another advantage is the overall decrease in the use of electricity generated by fossil fuels.

In another embodiment, a system is provided for retrofitting existing electric vehicles with wires to produce an electrical current from the Earth's magnetic field. A vehicle may also, for example, be constructed with the system built in.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 illustrates a computer assembly comprising a wire, voltmeter, wattmeter, vehicle motor, supercapacitor, and computer interface bus, with switches configured to charge the supercapacitor, according to an embodiment.

FIG. 2a illustrates the computer assembly of FIG. 1, with switches configured to connect the voltmeter across the supercapacitor.

FIG. 2b illustrates the connection of the voltmeter to the supercapacitor, by closing switches 2-S3 and 2-S4, as shown in FIG. 2a.

FIG. 3a illustrates the computer assembly of FIG. 1, with switches configured to connect the wattmeter across the motor.

FIG. 3b illustrates the connection of the wattmeter, motor, and supercapacitor, by closing switches 3-S5 and 3-S6, as shown in FIG. 3a.

FIG. 4 illustrates the computer assembly of FIG. 1, with switches configured to charge a backup battery.

FIG. 5a illustrates the top view of an exemplary circular arrangement of wires. FIGS. 5b-c illustrate the side views of two exemplary arrangements of FIG. 5a.

FIGS. 6a-d illustrate an exemplary nested coils arrangement of wires.

FIGS. 7a-b illustrate an example of retrofitting an electric vehicle with the nested coils system shown in FIGS. 6a-d.

FIG. 7c shows an example of a wire connected to a voltmeter.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

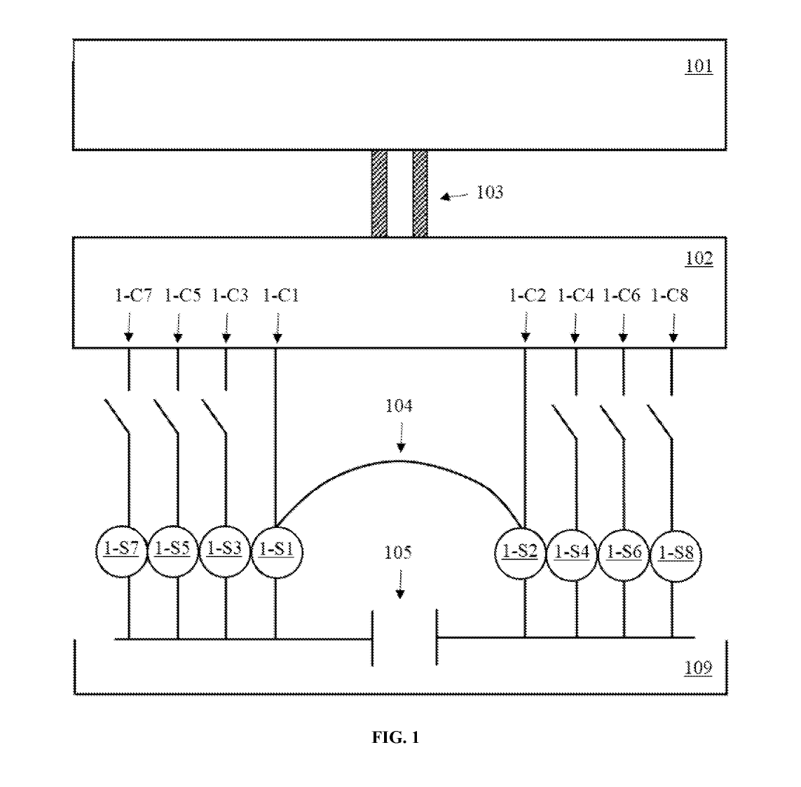

FIG. 1 illustrates a computer assembly according to an embodiment, comprising a wire 104, positive and negative connections 1-C1 and 1-C2 to a supercapacitor 105, positive and negative connections 1-C3 and 1-C4 to a voltmeter, positive and negative connections 1-C5 and 1-C6 to a wattmeter and vehicle motor, positive and negative connections 1-C7 and 1-C8 to a battery, all connected to each other via a computer interface bus 102 and a busbar 109. Information from the computer interface bus 102 may be sent to a computer 101 by wires 103 or any other means known in the art. The connections to the interface bus 102 can be made by closing switches 1-S1-1-S8, thereby connecting the circuits, and opening and closing of the switches may be controlled by the computer 101. When switches 1-S1 and 1-S2 are closed as shown in FIG. 1, the wire 104 is connected to the supercapacitor 105. The wire 104 is then able to charge the supercapacitor 105. According to a preferred embodiment, at any given time, there will be at least one wire in the correct position relative to the lines of flux of the Earth's magnetic field in order to generate voltage. This is done according to the following equation:

V=B×l×v

where V is the voltage generated in volts, B is the Earth's magnetic field, using 3×10⁻⁵ Tesla (T) as an example, as the strength may vary, l is the length of the wire, and v is the velocity of the wire.

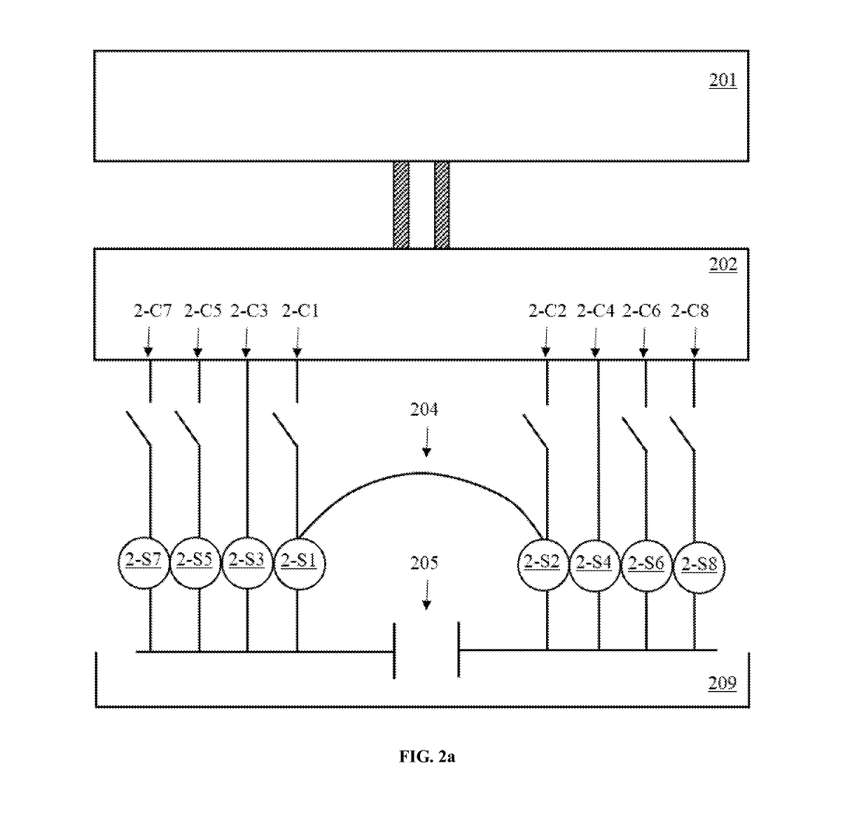

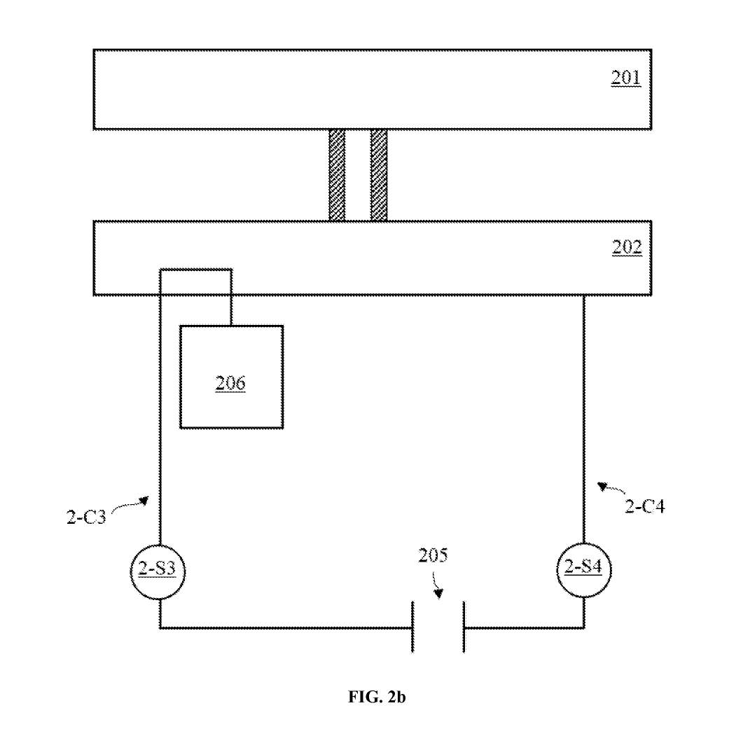

Switches 1-S1 and 1-S2 are then re-opened after a certain amount of time. As an example, 2-S1 and 2-S2 are opened after 100 milliseconds (ms) of charging the supercapacitor, which disconnects the charge, and switches 2-S3 and 2-S4 are closed (see FIG. 2a).

FIG. 2a-b illustrate the computer assembly of FIG. 1, with switches 2-S3 and 2-S4 closed to connect the voltmeter 206 across the supercapacitor 205, through the interface bus 202. The voltage may be read by the computer 201, which then can use the information to calculate the energy stored in the supercapacitor 205 by the following equation:

$$E = \frac{C {V}^{2}}{2}$$

where E is the energy in joules (J), c is the capacitance in farads (F), and V is the voltage in the supercapacitor 205 in volts (V).

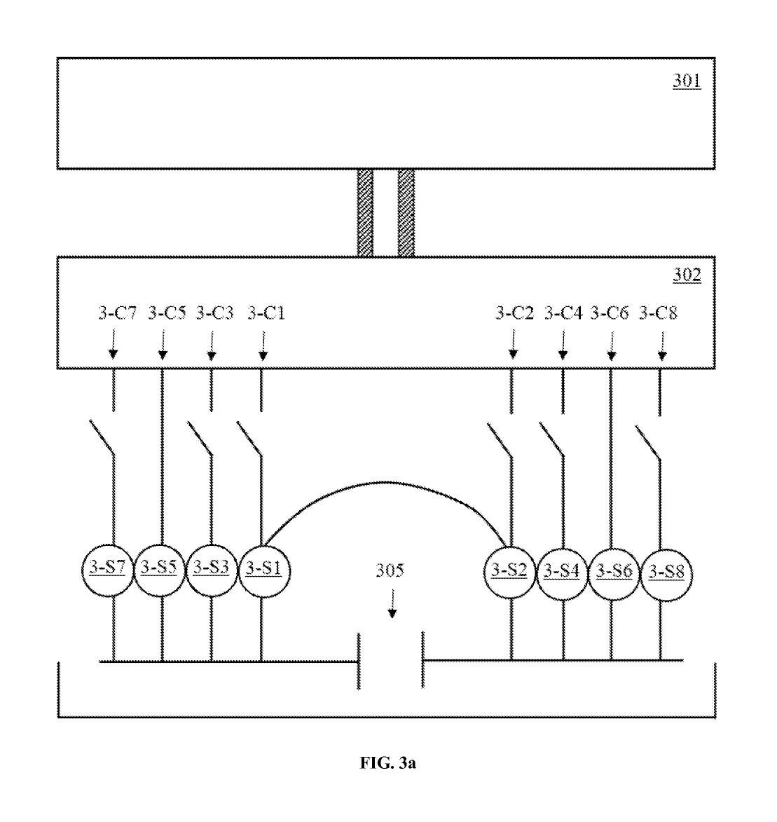

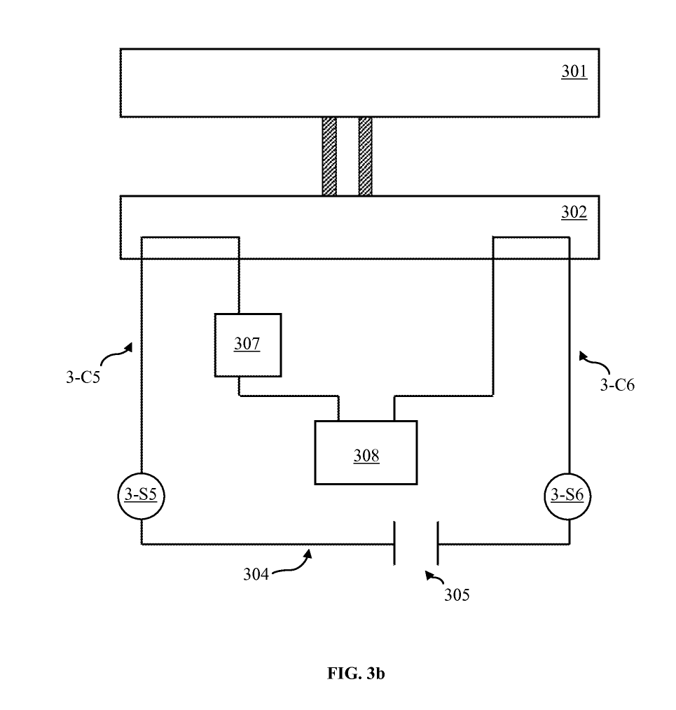

After some time (again, as an example, after 100 ms), S3 and S4 are then opened and 2-S1 and 2-S2 are again closed (FIG. 2a), such that the supercapacitor 205 can resume charging. Then, switches 3-S1 and 3-S2 are opened and switches 3-S5 and 3-S6 are closed (FIG. 3a), allowing the supercapacitor 305 to supply energy to the vehicle's motor 308 through circuits 3-C5 and 3-C6.

A system may be provided for the computer 101 to determine when to switch one supercapacitor 105 out for another when only a small amount of energy is left in the one currently supplying power to the motor. For example, when the energy in a first supercapacitor 105 falls to the amount of energy needed for two more seconds of use or other predetermined minimum energy level, a first set of switches associated with the first supercapacitor 1-S5 and 1-S6 may be opened and a first 1-S1 and 1-S2 are closed. Next, as an example, a second charged supercapacitor 105 is connected to the motor by opening a second 1-S1 and 1-S2, and closing a second 1-S5 and 1-S6. The computer 101 may be able to determine the order that the supercapacitors 105 should be discharged to the motor, battery, or computer 101 itself, and the time of discharge. Thus, it should be apparent that a plurality of supercapacitors is preferably used so that for example continuous power is provided to the motor.

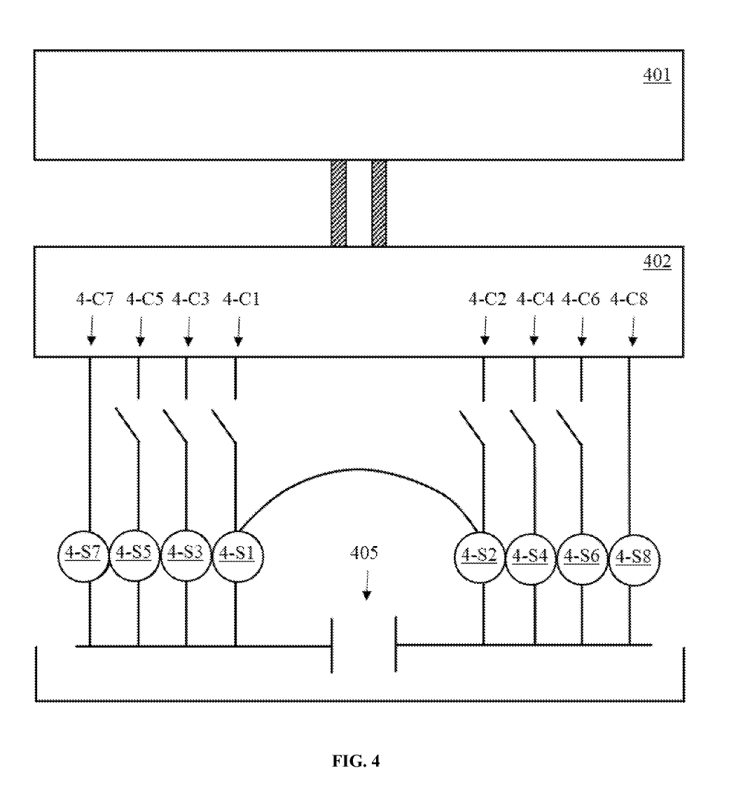

FIG. 4 illustrates the computer assembly of FIG. 1, with switches configured to charge a backup battery. Switches 4-S7 and 4-S8 may be closed when the vehicle is off, so that a battery connected by circuits 4-C7 and 4-C8 can be used to charge the supercapacitor 405 before starting the vehicle. If at any time the vehicle does not have enough power left in the supercapacitors 405, the back-up battery can be used. As an example, a vehicle may be initially started by using power from the supercapacitors having stored energy, or may be started by using power from a back-up battery. The battery may be charged by either the supercapacitors 405 or an AC charger (not shown). The computer 401 may check the voltage of the supercapacitor 405 by connecting the voltmeter as shown in FIG. 2b, and determine when the supercapacitor 405 is fully charged. The computer may perform this by opening switches 4-S7 and 4-S8 and closing switches 4-S3 and 4-S4 for voltage readings at designated intervals of time (for example, 100 ms) until the supercapacitor 405 is fully charged. The computer 401 may continue this monitoring process while the vehicle is in motion, to determine how many joules of energy is needed by measuring the voltage and the current going to the motor by monitoring the wattmeter 307.

It should be noted that the computer may be operated by any standard means known in the art.

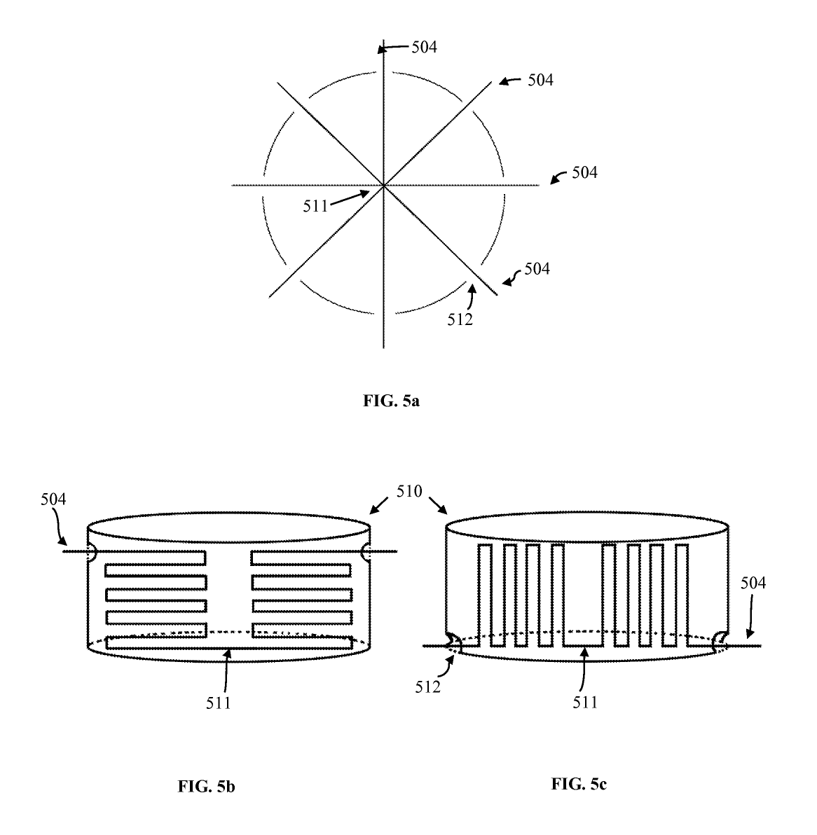

FIG. 5a illustrates the top view of an exemplary circular arrangement of wires 504. An advantage of the arrangement is that it allows there to be wires available at the correct position relative to the lines of flux of the Earth's magnetic field at any given time. FIGS. 5b-c illustrate the side views of two exemplary arrangements of FIG. 5a. Only four wires 504, each bisecting the cylinder 510, are shown for clarity. A plurality of wires, preferably as many as technically possible, may be placed inside of a cylinder 510, which may be of any material that will not interfere with the magnetic field. Each of the wires 504 may extend out of the cylinder 510, without electrical contact through holes 512 at both ends, and connect to the computer interface bus 109.

As shown in FIGS. 5b-c, with only a single wire in each figure for clarity, the wires 504 may be folded such that a long length of wire can be fitted into a small space in a cylinder 510. For example, a 305 m. wire can be folded as shown in either FIG. 5b or FIG. 5c so that it measures 2 m. across the diameter of the cylinder 510. Each wire 504 should preferably be folded such that an unfolded wire loop 511 remains flat with no other folds on top of it, at the center of the cylinder 510. This would allow for other wires 504 of the same folded configuration to lay across the diameter of the cylinder 510, each crossing all other wires without electrical contact among them, at the wire loop 511, as shown in the top view in FIG. 5a.

As an example, a set of copper wires 504 of a standard 2 AWG gauge may be used in the arrangement illustrated in FIGS. 5a and 5c in order to generate sufficient electricity to power an electric vehicle, as shown by the following equations. Energy at an exemplary rate of 40 J/s may be provided to the motor.

A standard round 2 AWG wire has a diameter of 0.654 centimeters (cm). Calculations can be made for an exemplary cylinder with a height of 1 meter (m) and a diameter of 2 m (200 cm), with a slightly larger actual cylinder diameter used to accommodate the unfolded wire loop 511 and the space needed between the wires in the folds so that they do not have electrical contact. The number of times a 2 AWG wire could be folded vertically across that cylinder is 200 cm/0.654 cm=305.8, approximately 305 times. The height 1 m×305 folds gives a total length of 305 m of wire. Using the following equation

V=B×l×v

B=3×10⁻⁵ T (an example within the range of the strength of the Earth's magnetic field at the Earth's surface), l=305 m, and v is an assumed velocity of the vehicle of 33.3 meters/second, so V=0.305 volts are obtained from one wire 504.

Since the wires 504 are copper, the resistivity p of the material is known, and calculated to be 0.5217 ohms (Ω) per 1000 m of 2 AWG copper wire using the equation

$$R = ρ \cdot \frac{l}{A}$$

where R is the resistance in ohms, l is the length of the wire in m and A is the cross-sectional area of the wire in m². To calculate the resistance for the 305 m wire, (0.5217/1000)·305=0.159Ω. Using this resistance, the power can be calculated with the equation

$$P = \frac{{V}^{2}}{R}$$

where V² is (0.305)²=0.093. Therefore 0.093/0.159=0.585 J/s is the rate at which power can be delivered from or to the supercapacitor 105 while charging, respectively, from a single wire.

The energy stored in a 10,000 F supercapacitor, which may be used as an example, is calculated with the equation

$$E = \frac{C {V}^{2}}{2}$$

where V² is (0.305)²=0.093. 0.093×10,000 farads/2=465 joules of energy in one supercapacitor.

A supercapacitor can supply a constant rate of power for a time t, in seconds (s), given by the equation

t=[c·(V_{charge}²−Vₘᵢₙ²)]/(2·p)

where V_{charge} is 0.305 V as calculated above, and Vₘᵢₙ is a desired 0.1 V remaining in the supercapacitor for optimum performance, and p is the desired rate of power to the motor of 40 J/s. V_{charge}² is (0.305)²=0.093 and Vₘᵢₙ is (0.1)²=0.01. t is [10,000·(0.093−0.01)]/2·40=10.375 s of power by one wire. With for example 152 wires, 152·10.375=1577 s, or approximately 26.2 minutes. Alongside this, the time it takes to charge one supercapacitor is 465 joules/0.585=794.9 s, or approximately 13.2 minutes. With the rate of charge being approximately half of the time it takes to discharge all supercapacitors to 0.1 V, the vehicle may be able to efficiently run at this exemplary velocity with a needed 40 J/s. For any rate of power needed by the motor, using the equation above, the amount of time the supercapacitor can deliver power to the motor can be calculated. The computer 301 may be controlling the order in which the supercapacitors 305 will connect to the wire 304 to charge, then connect to the motor 308 to discharge and provide power, and reconnect to the wire to recharge. The control of the discharge of energy from the supercapacitors 305 may be performed by any means known in the art.

In another embodiment, a larger number of wires may be used, or a number of smaller sets of wires can be used to equal one larger plurality of wires. More wires may also be used in order to supply more power if needed, and more wires may also be used to supply power to other parts of the vehicle, such as the lights, radio, or other components. Each wire may preferably connect via the interface bus 109 to an individual supercapacitor 105.

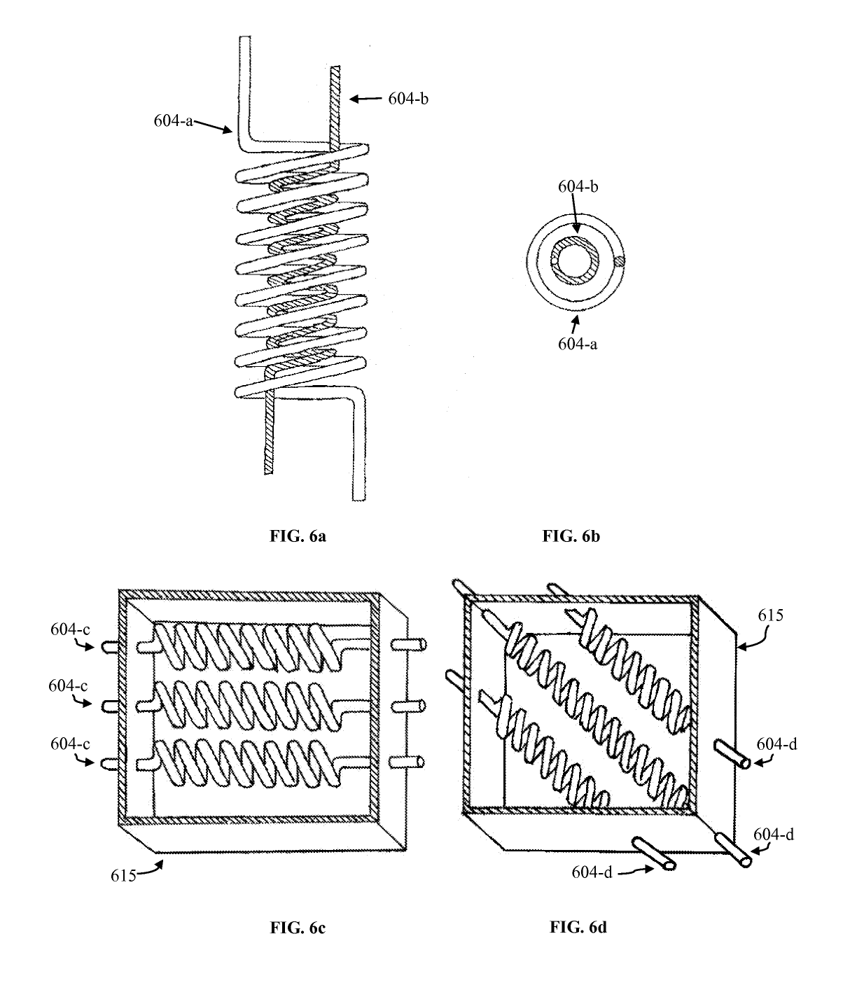

FIGS. 6a-d illustrate an exemplary nested coils arrangement of wires with no electrical contact. FIG. 6a-b illustrate the side and top views of two coiled wires 613 and 614, with wire 613 nested inside of wire 614. Only two wires are shown for clarity, but more wires may be used. FIG. 6c shows three wire coils 604-c which preferably each have additional coiled wires nested inside. FIG. 6d shows three wire coils 604-d pointed at an angle relative to wire coils 604-c. Only three sets of wire coils 604-c and 604-d are shown in each box 615 for clarity, though more or less may be used. Arranging the boxes with the wire coils 604-c and 604-d as shown in FIG. 6c-d allows there to be wires available at the correct position relative to the lines of flux of the Earth's magnetic field at any given time. As an example, wire coils 604-c in a box as shown in FIG. 6c may be positioned such that the wire coils 604-c are perpendicular to the ground, and may generate electricity as the vehicle travels in an east or west direction by cutting the lines of magnetic flux. As the vehicle changes direction to travel in a north or south direction, wire coils 604-d in a box as shown in FIG. 6d may be positioned at an angle (different than 90 degrees) to the ground, for example, at a 45 degree angle, and may generate electricity by cutting the lines of magnetic flux.

As an example, to achieve a rate of energy supplied to the vehicle motor of 40 J/s, a system of nested coils may be used, as shown in FIG. 6a-d. For example, three boxes 615 of four sets of nested wire coils, each set having four coils for a total of 48 coiled wires may be used for supplying electric current to 48 supercapacitors. Each wire (such as 604-a and 604-b shown in FIG. 6a-b) for the purposes of this example is a 0000 AWG copper wire having a wire diameter of 11.684 millimeters (mm). The resistivity of the material is known, and calculated to be 0.16072Ω per 1000 m using the equation

$$R = ρ \cdot \frac{l}{A}$$

where l is the length of one coiled wire in m. To find the length, first a coil diameter of 1 m is used. The circumference of one such coil is 2πr=3.1416 m. In one meter length, a wire of 0000 AWG diameter width could fit approximately 85 times (1000 mm/11.684 mm=85.6). Therefore, it takes 3.1416×85=267 m of wire to make 85 coils in a 1 m length of space.

Since 1 V derived from a single wire is desired, a longer length of wire is needed for this example. When 1000 m of wire is used to make coils of the dimensions described above, approximately 1000/267=3.75 m length of space is required to accommodate the coil, and the equation

V=B×l×v

can be used to find the amount of voltage generated from this wire. Using the same assumed variables as described above for the circular arrangement of wires, (3×10⁻⁵ T)×(1000 m)×(33.3 m/s)=1 V for a single wire. Since 1 V is generated from 1000 m of wire, and the resistivity is 0.16072Ω per 1000 m at this length, the power generated is

$$P = \frac{{V}^{2}}{R}$$

(1)²/0.16072=6.22 J/s. This is the rate at which power can be delivered from or to the supercapacitor while discharging or charging, respectively.

The amount of energy stored in a supercapacitor is found using the equation

$$E = \frac{C {V}^{2}}{2}$$

where the supercapacitor has a capacitance of 10,000 farads. [(10,000)×(1)²]/2=5,000 J. The amount of time that a supercapacitor can provide a constant output of power is given by

t=[c·(V_{charge}²−Vₘᵢₙ²)]/(2·p)

where, again as was described above, Vₘᵢₙ is 0.1 volts left in the supercapacitor for optimum performance and V_{charge} is 1. [10,000·(1−0.01)]/2·40=123.75 s, or approximately 2.06 minutes, is therefore the duration of time that a supercapacitor can provide a constant output of power from one wire.

The second coil 604-b, also a 0000 AWG wire, inside of the first coil 604-a may preferably have a smaller diameter of coils in order to fit inside, as shown as an example in FIG. 6a-b. Four coils of similar length are therefore used as a set in this example, each coil nesting inside of another with the smallest diameter of coil as the innermost wire.

With a coil diameter of 0.92 m, the second wire 604-b can nest inside of the first wire 604-a and the circumference of one coil of the second wire 604-b is (0.92×π)=2.89 m. Using the same equations outlined above, the same amount of power 6.22 J/s can be provided, for 123.75 seconds. With a set of four coils nested one inside of the other (see FIG. 6a), this amounts to 24.88 J for a duration of 495 s, or approximately 8.25 minutes of constant power output from one set. Approximately 20 J/s can be provided to the vehicle with this set, since 495/24.88=19.89. Because preferably more sets of coils may be used, three sets of coils may be provided to achieve over the needed 40 joules of per second (1485/18.66=79.6 joules).

The time for recharge of one supercapacitor 305 using one wire coil set 604-c or 604-d is 5000 joules/24.88=200.96 seconds, or approximately 3.36 minutes. Since this is under the 8.25 minutes of constant power from another set, the vehicle may be able to efficiently run at this exemplary velocity of 33.3 m/s, with the computer 301 controlling the order in which the supercapacitors 305 will connect to the wire 304 to charge, then connect to the motor 308 to discharge and provide power, and reconnect to the wire 304 to recharge. The control of the discharge of energy from the supercapacitors 305 may be performed by any means known in the art.

In another embodiment, a larger number of wires may be used, or a number of smaller sets of wires can be used to equal one larger plurality of wires. More wires may also be used in order to supply power to other parts of the vehicle, such as the lights, radio, or other components. Each wire may preferably connect via the interface bus 109 to an individual supercapacitor 105.

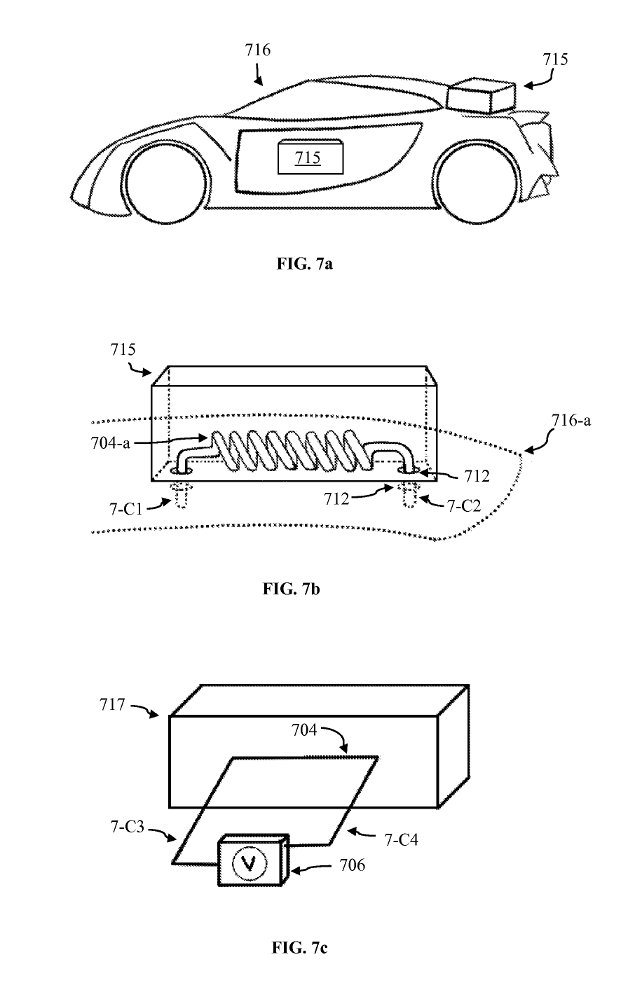

FIG. 7a illustrates a side view of an electric vehicle retrofitted with a system of nested coiled wires as in FIGS. 6a-d, according to an embodiment. An electric vehicle may be retrofitted with, for example, a circular arrangement of wires in a cylinder (FIGS. 5a-c), or a nested coiled wires arrangement in a box (FIGS. 6a-d) in order to provide power to the vehicle's motor. In one embodiment, a set of boxes is placed in or on the vehicle (FIG. 7a). A plurality of coils, each preferably containing one or more coils nested inside, are placed in each box. FIG. 7b illustrates a wire 704-a which may be coiled and placed inside of a box 715 such that the box can be mounted anywhere on a vehicle. The wire 704-a may, for example, connect to a computer interface bus 102 via circuits 7-C1 and 7-C2. The computer interface bus 102 may be located in the interior of the vehicle, in which case the wire 704-a may reach the bus 102 by exiting the box 715 through holes 712 and 712-a of the box 715 and body of the vehicle 716-a, respectively.

FIG. 7c shows an example of a wire 704 connected to a voltmeter 706. What follows is a succinct presentation of the experiments conducted to arrive at the systems and methods disclosed above. A vehicle was used to carry the wire 704 connected to a voltmeter 706 by circuits 7-C3 and 7-C4. The wire 704 and voltmeter 706 were attached to the vehicle by a wooden board 717, which does not impede the magnetic field and provided insulation for the wire 704, protecting it from any interference from the vehicle. The experiment was performed on a small scale, driving the vehicle with only one wire 704 and taking readings from the voltmeter 706. The experiment showed that the voltage collected by the wire 704 was sufficient to provide enough energy to an electric vehicle as disclosed above if the number of wires were to be increased.

It should be understood that retrofitting a vehicle with the systems described herein and exemplarily shown in FIG. 7a-c may be performed in any manner deemed suitable, such as, for example, including the system in a trailer hitched to the vehicle, using a bicycle rack or other such similar device to carry the system, or attaching the system onto the roof, doors, undercarriage, or interior of the vehicle using any suitable method. An electric vehicle may also be constructed with the system already built in, or the body of an electric vehicle may for example be constructed with other similar suitable technology such as, for example, integrated circuit technology, such that the body is made up of sheets of conductive material such as copper to allow the vehicle body to act as the copper wires. The sheets of copper may, for example, be etched in order for them to act as the wires as described in the system herein.

It should be understood that the inventive aspects disclosed herein may be adapted for various other applications, such as, for example, powering a space station, drones, airplanes or satellites, which may eliminate reliance on solar panels.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

As used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims. Use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A method for powering a machine having a motor comprising the steps of:
powering the machine's motor using power from a power source;
using the motor to start to move the machine so as to move a plurality of wires associated with the machine within Earth's magnetic field, and thus, generate electrical energy within the plurality of wires;
using a computer, controllably supplying the electrical energy for storage to a plurality of energy storing devices by monitoring an energy level of each of the plurality of energy storing devices and directing the electrical energy to the energy storing device in which the energy level is below a predetermined level; and
using the computer, controllably supplying to the motor electrical energy from the plurality of energy storing devices by monitoring the energy level of each of the plurality of energy storing devices and supplying the electrical energy from the energy storing device in which the energy level is higher than the predetermined level; and
continuing to use the motor to move the machine.

2. The method of claim 1, wherein the machine is an electric vehicle.

3. The method of claim 1, wherein the power source is a battery.

4. The method of claim 1, wherein the energy storing devices are supercapacitors.

5. The method of claim 1, wherein the wires are copper wires.

6. The method of claim 1, wherein each wire from the plurality of wires is associated with a corresponding energy storing device from the plurality of energy storing devices.

7. The method of claim 1, wherein the plurality of wires is arranged in a circular configuration such that at least a wire of the plurality of wires has the correct position relative to the Earth's magnetic field lines of flux of at any given time.

8. The method of claim 7, wherein each wire from the plurality of wires is folded and placed radially in a cylinder across the diameter of the cylinder, such that to achieve a maximum length for each of the plurality of wires, a maximum total length of the plurality of wires and correct position relative to the Earth's magnetic field lines of flux of at any given time of the at least a wire.

9. The method of claim 1, wherein the plurality of wires is formed in a plurality of nested coils, wherein a first group of the nested coils is positioned to be at a first angle with the ground, and wherein a second group of nested coils is positioned to be at a second angle, with the ground.

10. The method of claim 1, wherein the plurality of wires is formed in a plurality of nested coils, wherein a first group of the nested coils is positioned to be perpendicular to the ground and wherein a second group of nested coils is positioned to be at an angle, different than 90 degrees, with the ground.

11. The method of claim 2, wherein the plurality of wires is integral to the body of the electric vehicle.

12. A system for using the Earth's magnetic field to power a machine having a motor, the system comprising a computer, a plurality of wires, a plurality of energy storing devices, all in controlled electrical communication with each other, wherein the plurality of wires can collect electrical energy from the Earth's magnetic field while the machine is put in motion by a power source powering the motor, wherein the collected electrical energy is stored in the plurality of energy storing devices or used to power the motor.

13. The system of claim 12, wherein the machine is an electric vehicle.

14. The system of claim 12, wherein the power source is a battery.

15. The system of claim 12, wherein the energy storing devices are supercapacitors.

16. The system of claim 12, wherein each wire from the plurality of wires is associated with a corresponding energy storing device from the plurality of energy storing devices.

17. The system of claim 12, wherein the plurality of wires is arranged in a circular configuration such that at least a wire of the plurality of wires has the correct position relative to the Earth's magnetic field lines of flux of at any given time.

18. The system of claim 17, wherein each wire from the plurality of wires is folded and placed radially in a cylinder across the diameter of the cylinder, such that to achieve a maximum length for each of the plurality of wires, a maximum total length of the plurality of wires and correct position relative to the Earth's magnetic field lines of flux of at any given time of the at least a wire.

19. The system of claim 12, wherein the plurality of wires is formed in a plurality of nested coils, wherein a first group of the nested coils is positioned to be at a first angle with the ground, and wherein a second group of nested coils is positioned to be at a second angle, with the ground.

20. The system of claim 13, wherein the plurality of wires is integral to the body of the electric vehicle.
